(19) United States
(12) Patent Application Publication
(10) Pub. No.: US 2003/0006527 A1
(43) Pub. Date: Jan. 9, 2003

(54) Method of fabricating micron-and submicron-scale elastomeric templates for surface patterning

(76) Inventors: John F. Rabolt, Greenville, DE (US); Mei-Wei Tsao, Wilmington, DE (US)

Correspondence Address: CONNOLLY BOVE LODGE & HUTZ LLP, 1220 Market Street, Post Office Box 2207, Wilmington, DE, 19899, US

(21) Appl. No.: 10/178,008

(22) Filed: Jun. 21, 2002

Related U.S. Application Data
(60) Provisional application No. 60/300,185, filed on Jun. 22, 2001.

(51) Int. Cl. B29C 33/40

(52) U.S. Cl. 264/220; 264/236

(57) ABSTRACT

The present invention relates to the fabrication of elastomeric replicas or stamps of surfaces from a stamp master, wherein the master has geometrical features below 100 μm. The elastomeric stamps of the present invention are prepared from injection-molded plastic stamp masters. The stamps are used to replicate the surfaces or patterns of the stamp master on a substrate using soft lithography techniques.

### CLAIM OF PRIORITY

Priority is claimed under 35 U.S.C. §119(e) from the U.S. Provisional Application Serial No. 60/300,185 filed on Jun. 22, 2001 which is herein incorporated by reference.

### FIELD OF THE INVENTION

The present invention relates to the fabrication of elastomeric replicas or stamps of surfaces from a stamp master, wherein the stamp master has geometrical features below 100 μm and is made of plastic or other flexible materials.

### BACKGROUND OF THE INVENTION

High-resolution patterning techniques are among the key elements that has lead to modern microelectronics manufacturing processes. Numerous methods have been used to spatially create precisely defined electronic elements in electronic circuits.

The art of lithography was used for circuit patterning long before the advent of integrated circuits (“IC”). For example, during World War II, the Centralab Division of Globe-Union Inc. developed a ceramic-based circuit for the National Bureau of Standards. This circuit was prepared using screen-printed resistor inks and silver paste to define miniature circuits. These circuits were used in a proximity fuse for the United States Army. Additionally, in 1943, P. Eisler in the United Kingdom developed a manufacturing process for complex circuits based on a layer-by-layer printing technique. See UK Patent No. 639 178.

Since the advent of the integrated circuit in 1959, a combination of different lithographic techniques has been used for circuit patterning on substrates. Furthermore, during the course of progress in integrated circuit development, the feature sizes of these patterns have been steadily declining.

Modem semiconductor manufacturing is based on photolithography, a method that is based on feature-imaging using visible and ultraviolet (UV) lamps or lasers. In photolithography, specialized tools for image exposure and development are required. Masks that define the circuit layers have to be made with electron-beam direct writing to achieve the precision tolerance required. In addition, as shorter wavelength ultraviolet light is used to achieve the high circuit density demanded by modem semiconductor manufacturers, special photo-sensitive materials called photoresists must be applied to the substrate during the patterning process. As a result of these stringent technical requirements, the costs associated with photolithography currently account for about 30 to 60 percent of the total manufacturing costs in modem semiconductor production.

Soft lithography is an alterative to photolithography. Soft lithography allows for the transfer of features by mechanical interactions between two surfaces such as embossing or printing. The adjective “soft” in the phrase “soft lithography” refers to the elastomeric stamps or molds that are used. Printing by soft lithography was first demonstrated by E. Chandross et al. from Bell Laboratories in 1972. The example given in their paper was an embossed optical waveguide having a width of 7 μm. See E. Chandross et al., Applied Physics Letters, Vol. 20, p213-215 (1972). In soft lithography a printing stamp master having small features is pressed into a pliable substrate, replicating the features. The resulting three-dimensional patterns are then used as device components. One use of these device components is fluid channels.

While the general technique of soft lithography was developed around 1972, micron-scale high-resolution soft lithography by contact printing was not developed until the late 1980s. At this time, G. Whitesides et al. successfully cast micron-scale features using curable elastomers such as poly(dimethyl siloxane), which is also known as “PDMS”, or “silicone”. In a paper published in 1993, Whitesides et al. described preparing PDMS “stamps” from patterned (etched) silicon wafers, then “inked” the stamps and transferred the 10 μm features onto surfaces. See G. Whitesides and A. Kumar, Applied Physics Letters, Col. 63, p2002-04 (1993). A more-recent paper by the same authors also demonstrated a method to make PDMS stamps using microfiche film as the photo mask. See Whitesides et al., Analytical Chemistry, Vol. 72, 3176-80 (2000). The pattern was then transferred to a silicon wafer with photoresist using the images of the masks. Soft lithography is also described in Qin, D., et al., Microfabrication, Microstructures and Microsystems, Topics in Current Chemistry, Vol. 194, p. 2-20 (1998), which is hereby incorporated by reference.

The high-resolution printing of the present invention is substantially superior over the prior art soft lithography and lithography. The improved high-resolution printing is the result of using a plastic stamp master that effectively eliminates both: (1) the mismatch of the thermal expansion between the stamp and the stamp master; and (2) the heterogeneous release interfaces made of hard and soft materials. Both factors can introduce defects and infidelity into the final printed structures.

Additionally, the curvature-printing advantage of this invention is due to the fact that the silicone stamp can be cast from a plastic stamp master with a non-planar surface. The use of a non-planar surface better matches the printing surfaces to be printed with the stamps. In typical contact printing the silicone stamps are usually cast from planar structures made of silicon or metals. These stamps are then deformed during printing to conform to the contours of the substrate. The deformed or stressed silicone stamps usually introduce defects or misalignment to the final printed structures. In the present invention, by which one can cast silicone stamps directly from a curved injection-molded stamp master, the stamp will be under significantly lower stress during the final printing and therefore higher fidelity of the features will result.

### SUMMARY OF THE INVENTION

The invention comprises a method for forming printing stamps using injection-molded plastic stamp masters. Particularly contemplated are high-resolution silicone stamps with features of less than 1 μm. In contrast to the prior art, where the stamp masters for fabricating the stamps are always in the form of silicon substrates with patterns formed by photolithography, the present invention embodies the use of rigid or flexible plastic stamp masters formed by ordinary injection-molding processes. Such injection molding processes are similar to that by which plastic COCA-COLA® bottles and disposable plastic tableware are made. The inventors have unexpectedly found superior results with the present invention compared to soft lithography methods known in the prior art.

A key feature of the present invention is the use of a plastic stamp master to create the silicone stamps, which consequently produces high-resolution features with critical dimensions below 1 μm. While the inventors do not wish to be bound to a particular theory, they believe that the mechanical and thermal similarities between the casting elastomer (a polymer) and the plastic stamp master (also a polymer) are the reason that submicron resolution is possible using the method of the present invention.

In a preferred embodiment of the invention, the method of the present invention comprises:

(a) providing an injection-molded plastic stamp master, wherein the stamp master has a pattern and said pattern has at least one feature below 100 μm in size;

(b) casting an elastomeric printing stamp using the stamp master by contacting an elastomer to the stamp master; and

(c) curing the elastomeric printing stamp.

Optionally, the method further comprises the steps:

(d) determining the geometrical dimensions of the cured elastomer printing stamp;

(e) transferring the pattern of the elastomeric printing stamp to a substrate using soft lithography; and/or

(f) characterizing the quality of the transferred pattern.

For steps (d) and (f), the technique of atomic force microscopy (AFM) is applied and it is known that other techniques such as scanning electron microscopy (SEM) and transmission electron microscopy (TEM) can also be applied for the same purposes.

In comparison with the prior art silicon or metal-based stamp masters that are commonly used for soft lithography, the present invention is particularly suited for applications that require the printing of high-resolution structures, e.g., structures with feature size around or below 1 μm and where curvature-printing is required, e.g., printing cylindrical, spherical or parabolic surfaces.

The process of the present invention can also find applications in many modern devices found in electronics, photonics, displays, optical components, fiber optics/telecommunication, and microfluidics. Further, the process of the present invention can be applied to the printing of electronic circuits where inks of conductive, resistive, and semiconductive nature can be used to lay out the entire circuit without the need of masking and etching processes. Additionally, the process of the present invention can be used for the printing of both thin and thick film devices used in information displays such as television, computer monitor, personal digital assistants (“PDAs”), and cellular phones. Active and passive elements can both be printed with the high accuracy needed for image and video rendering.

The process of the present invention can further find applications in coating optical components such as windows and detectors where precise control of the coating dimensions is needed for the component to function. Some of such optical components have curved surfaces where the present invention is particularly useful.

The process of the present invention can also be used to print components found in fiber optics, photonics, and telecommunication applications. In particular, the curvature printing ability and the high resolution of the present invention can be used as a means to print Bragg grating around the outside of optical fibers. Bragg grating fibers are needed for wavelength multiplexing applications, a method used to increase the information bandwidth. An example of such an application is Dense Wavelength Digital Multiplexing (“DWDM”) filters where hundreds or thousands of layers of coatings need to be applied to a substrate in order to achieve the filter performance. With each channel size approximately 25 μm in diameter, high-resolution printing can provide large channel count in a single element while keeping the performance of each channel high.

Still another embodiment of the present invention is that the process can be used to define three-dimensional features found in microscopic fluid channels used in microfluidics. While sub-microliter sampling is a new trend in medical diagnostics and drug development, it is not always easy to transport samples in such a minute quantity. A particularly preferred embodiment of the present invention offers a way to introduce micron-sized channels, junctions and wells into a device which can in turn be used as the “plumbing” system needed for microfluidics.

### LIST OF FIGURES

FIG. 1. Tapping-mode AFM topography image of an injection-molded stamp master (a) and its cross-sectional profile.

FIG. 2. Tapping-mode AFM topography image of a silicone stamp cast from the stamp master shown in FIG. 1; and its cross-sectional profile.

FIG. 3. Tapping-mode AFM images of a printed structure of parallel grooves, replicated from the injection-molded stamp master from FIG. 1.

FIG. 4. Tapping-mode AFM images of a printed structure of PDMS-SH solution on gold, replicated from the injection-molded stamp master from FIG. 1.

| | DEFINITIONS |
|---|---|
| Mold. | A device that has the pattern of feature(s) incorporated into |
| | it to be ultimately transferred to the substrate. |
| Elastomer. | Any of various elastic materials that resemble rubber in |
| | that the material resumes its original shape when a |
| | deforming force is removed. |
| Siloxane. | Any of a class of organic or inorganic chemical compounds |
| | of silicon, oxygen, and usually carbon and hydrogen, based |
| | on the structural unit R₂SiO, where R is an alkyl group, |
| | usually a methyl group. |
| Injection | The process where a plastic is heated above its melting |
| molding. | temperature and introduced into a die or mold to produce |
| | a molding. |
| Plastic. | Engineering polymers known in the art to be suitable for |
| | injection molding. |
| Pattern. | A collection of at least one feature that is provided on the |
| | plastic stamp master. |
| Feature. | An element that is desired to be transferred to the substrate. |
| | For the purposes of this invention, the feature is on the |
| | order of 100 μm or smaller. |
| Stamp | An injection-molded device that incorporates the pattern of |
| master. | feature(s) to be transferred to the printing stamps. |
| Casting. | Introducing the elastomer to the injection-molded stamp |
| | master to prepare the printing stamp. |
| Printing | The device used to transfer the pattern of feature(s) of the |
| stamp. | stamp master to a substrate. |
| Substrate. | The material to which the pattern of feature(s) of the mold |
| | is transferred using the printing stamp. |
| Pattern | Any process of contacting the printing stamp to the |
| transfer. | substrate. |
| Soft | Soft lithography allows for the transfer of features by |
| Lithography. | mechanical interactions between two surfaces such as |
| | embossing or printing. The adjective “soft” in the phrase |
| | “soft lithography” refers to the elastomeric stamps or molds |
| | that are used. |

### DETAILED DESCRIPTION OF THE INVENTION

The invention as described will find particular use in device fabrication, such as photonics, optical communication, electronics, and microfluidics. Examples of the plastic stamp masters with grooved features, which are provided as exemplary and are not limiting on the scope of the method, include: trenches, vias, square pixels, round pixels, elliptical pixels, mesa structures, and antenna lines. Examples of the polycarbonate stamp masters, which is provided as exemplary and is not limiting on the scope of the method, include all engineering polymers with good injection-molding properties can be found in J. Brandrup, E. H. Immergut, and E. A. Grulke, Polymer Handbook, 4th ed., Wiley, (1999).

The preferred means of printing stamp fabrication is through the use of plastic stamp masters manufactured by injection-molding. This technique involves the molding of plastics by pressing a hot polymer melt through and into a die or mold. The mold incorporates the desired pattern of features. Upon solidification, the polymer permanently takes on the dimension and surface characteristics of the pattern of the die or mold. In this manner, stamp masters for the soft lithography printing stamps can be manufactured in large quantities relatively inexpensively. In contrast, the preparation of stamps using photolithography is notoriously expensive.

The stamp master is then used for the fabrication of elastomeric stamps by casting an elastomeric material against the stamp masters using any suitable method known in the art for such purposes. See, e.g., U.S. Pat. No. 6,048,623, which is herein incorporated by reference.

The elastomeric stamps of the present invention are flexible to accommodate different substrate forms such as planar, cylindrical, spherical or parabolic surfaces. In a preferred embodiment, the elastomeric stamps of the present invention are prepared from silicone elastomer (“SYLGARD® 184”, available from Dow Corning Corp., Midland, Mich.).

In a preferred embodiment, the elastomer is cured after it is cast. The curing conditions of the elastomeric stamps are a factor in the quality of the finished elastomeric printing stamps. In a preferred embodiment of the present invention, the elastomeric printing stamps are cured for 12 hours at 60° C. In this embodiment, the stamps produced have been found to provide the optimal chemical and physical properties for soft lithography, such as release and compliance behavior.

### EXAMPLES

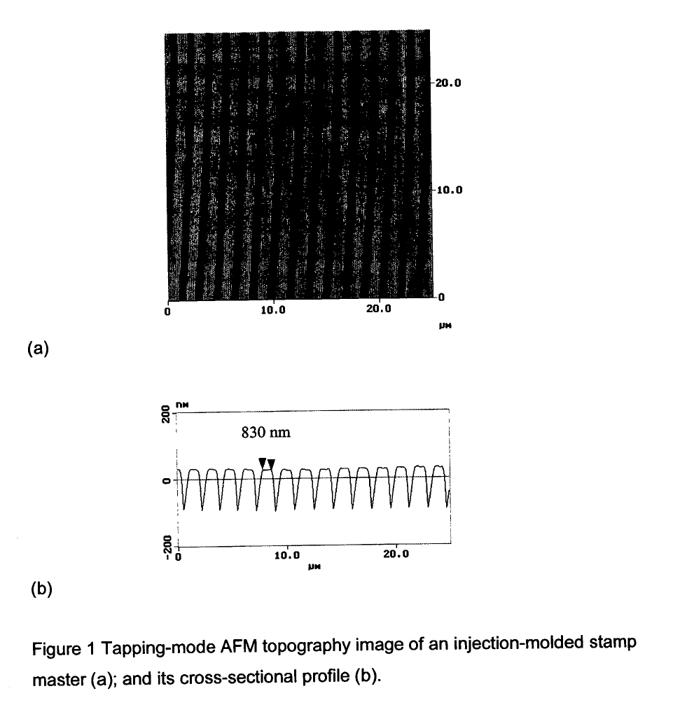

In an example, shown in FIG. 1, the stamp master is fabricated with polycarbonate using commonly known injection-molding techniques.

The mold used for the injection molding process of the present invention is made in the following way. The original patterns are fabricated onto a glass or sapphire substrate by single-point diamond turning. These patterns are then converted to metal by electroless nickel plating of the patterned substrates. The final metal mold, or stamper, is made by bonding the patterned nickel to a metal backing.

The injection molding process is carried out with the stamper held stationary and a matching moving press sandwiching the polymer melts. In this example, the polymer is polycarbonate. The polycarbonate is initially heated and dried at 120° C. Next the polycarbonate is further heated to 320° C. At this temperature, the polymer is in a molten state. The polycarbonate melt is driven by an extrusion screw into the space inside the mold. The filled mold is then cooled. After cooling, the molded part is punched out of the mold and inspected. The resulting surface of the plastic stamp master has a series of densely packed grooves which are less than 1 μm in width and several centimeters in length.

Using the mold prepared above, a silicone printing stamp was cast from the plastic stamp master. The PDMS printing stamp was formed using the following process. The injection-molded stamp master was placed in a plastic dish, and a 10:1 ratio mixture of SYLGARD® 184 silicone elastomer and a curing agent (available from Dow Corning Corp., Midland, Mich.) was poured over the stamp master surface. The elastomer and curing agent was allowed to cure for at least 12 hours in an oven at 60° C. The resulting PDMS film, which was about 1-3 mm in thickness, was peeled off the plastic stamp master for use as soft lithography stamps. The edges of the stamps are trimmed to match the surface geometry to be printed. Harder and tougher films can result by increasing the amount of curing agent used. Prior to use as a printing stamp, the PDMS stamp was washed several times with ethanol and dried with a stream of dry nitrogen.

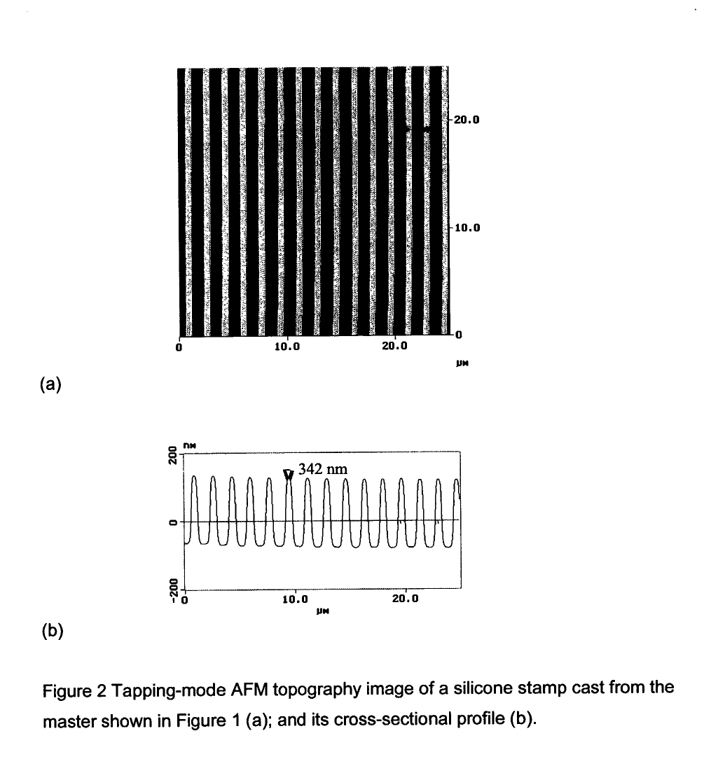

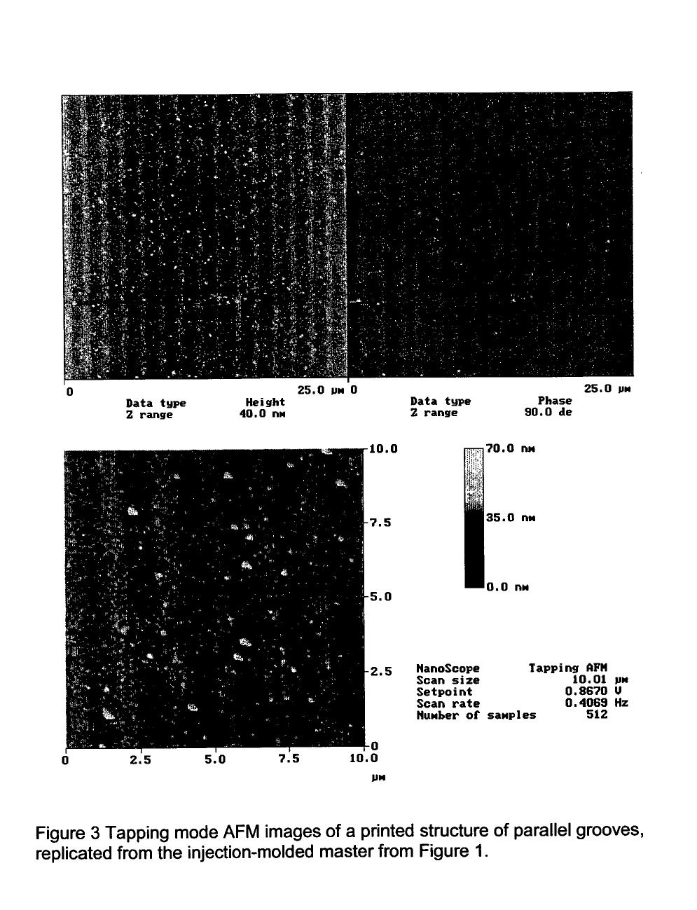

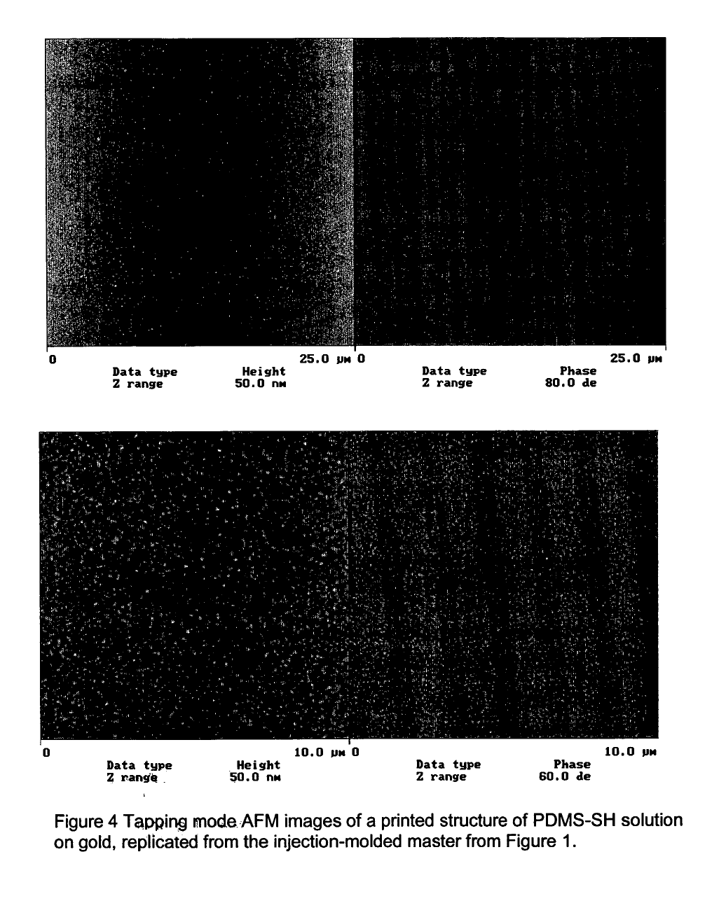

The silicone stamp cast from the injection-molded plastic stamp master, is shown in FIG. 2. In FIG. 2(b), the densely packed grooves can be seen to have transferred from the stamp master to the silicone stamp with high fidelity. Inking and printing with the silicone stamps produce structures on the substrate. These structures are shown in FIG. 3 and FIG. 4. As these images indicate, features of less than 1 μm in width can clearly be printed onto the surfaces of the substrate.

While the invention has been particularly shown and described with reference to preferred embodiments thereof, it will be understood by those skilled in the art that various changes in form and details may be made without departing from the spirit and scope of the invention as defined in the appended claims.

We claim:

1. A method to form an elastomeric printing stamp comprising:
(a) providing an injection-molded plastic stamp master, wherein the stamp master has a pattern and said pattern has at least one feature below 100 μm in size;
(b) casting an elastomeric printing stamp using the stamp master by contacting an elastomer to the stamp master; and
(c) curing the elastomeric printing stamp.

2. The method of claim 1 further comprising a step (d), determining the geometrical dimensions of the cured elastomer printing stamp.

3. The method of claim 1 further comprising a step (e), transferring the pattern of the elastomeric printing stamp to a substrate using soft lithography.

4. The method of claim 3 further comprising a step (f), characterizing the quality of the transferred pattern.
